(19) United States
(12) Patent Application Publication
(10) Pub. No.: US 2008/0158346 A1
(43) Pub. Date: Jul. 3, 2008

(54) Compound eye digital camera

(75) Inventors: Satoru Okamoto, Asaka-shi (JP); Mikio Watanabe, Asaka-shi (JP); Satoshi Nakamura, Asaka-shi (JP); Toshiharu Ueno, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 12/005,361

(22) Filed: Dec. 27, 2007

(30) Foreign Application Priority Data
Dec. 27, 2006 (JP) 2006-353208

(51) Int. Cl. H04N 13/02; H04N 13/04; H04N 5/225

(52) U.S. Cl. 348/47; 348/51; 348/207.99; 348/E13.003; 348/E13.004

(57) ABSTRACT

An image management method which creates and records two or more real images and two or more thumbnail images from two or more images by viewpoints photographed by two or more image pickup devices corresponding to the viewpoints, wherein the real images include a stereoscopic image including the images by viewpoints, a common image range cut from the images by viewpoints and a whole image synthesized from the images by viewpoints, and the thumbnail images include two or more thumbnail images y each viewpoint corresponding to each of images by viewpoints, a 3D thumbnail image corresponding to the stereoscopic image, and a whole thumbnail image corresponding to the whole image.

### BACKGROUND OF THE INVENTION

1. Field of the Invention

The present invention relates to a digital camera, and in particular, relates to a method of managing two or more images by viewpoints photographed by two or more image pickup devices which correspond to the two or more viewpoints.

2. Description of the Related Art

Heretofore, it is performed to record 3D image data, which is a set of images which have 2D image data and parallax, in a predetermined format with management information, such as an image kind, and the thumbnail images (refer to Japanese Patent Application Laid-Open No. 2004-120165).

Generally, in a stereoscopic and multiaspect image, an unnecessary portion on 3D display may not be displayed. Depending on a case, a portion necessary as a 3D image may remain by editing, and an image in a portion which is not contributed to 3D display may be discarded.

In addition, there are Japanese Patent Application Laid-Open Nos. 2004-120176, 2004-120216, 2004-120227, 2004-120246, 2004-120247, 2004-163998, and 2004-336701 as those relating to the present application.

Nevertheless, depending on the case, an object subject may be photographed in an image in an edge which is unrelated to 3D display, and hence, there is a problem that the object subject cannot be searched only from 3D images.

The present invention is made in view of such a situation, and aims at making it possible to search easily a subject photographed in an image portion in an edge and so on not appearing in 3D display.

### SUMMARY OF THE INVENTION

The present invention is made in order to solve the aforementioned problem, and an invention according to a first aspect is an image management method which creates and records two or more real images and two or more thumbnail images from two or more images by viewpoints photographed by two or more image pickup devices corresponding to the viewpoints, wherein the real images include the images by viewpoints, a stereoscopic image including a common image range cut from the images by viewpoints and a whole image synthesized from the images by viewpoints, and the thumbnail images include two or more thumbnail images by each viewpoint corresponding to each of the images by viewpoints, a 3D thumbnail image corresponding to the stereoscopic image, and a whole thumbnail image corresponding to the whole image.

According to the invention according to the first aspect, from the two or more images by viewpoints photographed by two or more image pickup devices corresponding to two or more viewpoints (for example, two viewpoints), two or more real images (in the case of two viewpoints, a total of four real images of a real image at a right viewpoint, a real image at a left viewpoint, a stereoscopic image, and a whole image), and two or more thumbnail images (in the case of two viewpoints, a total of four thumbnail images of a thumbnail image at a right viewpoint, a thumbnail image at a left viewpoint, a stereoscopic thumbnail image, and a whole thumbnail image) are created, and they are recorded as, for example, an image file in a predetermined image format.

That is, real images, thumbnail images, and the like, which are classified by the viewpoint, besides a stereoscopic image and a stereoscopic thumbnail image are also recorded.

Hence, as the conventional, even if a portion necessary as a 3D image remains by editing and an image in a portion which does not contribute to 3D display is discarded, it is possible to display a real image, a thumbnail image, and the like, which are classified by a viewpoint (thumbnail images by viewpoints), besides a stereoscopic image and a stereoscopic thumbnail image, and hence, it becomes possible to search easily a subject photographed in an image portion and the like in an edge not appearing in 3D display.

An invention according to a second aspect is the method according to the first aspect, comprising displaying the whole image and a marking for indicating a range of the images by viewpoints in the whole image or a range of the stereoscopic image in the whole image.

According to the invention according to the second aspect, the marking (for example, a cursor) for indicating the range and the like of the two or more images by viewpoints in a whole image in addition to the whole image (for example, making the marking superimposed on the whole image) is displayed.

Hence, it becomes possible to grasp easily a range of two or more images every viewpoint in a whole image, and a range of a stereoscopic image.

An invention according to a third aspect is the method according to the first aspect comprising displaying at least one image of the images by viewpoints and a marking for indicating a range of the stereoscopic image in the displayed image.

According to the invention according to the third aspect, a marking (for example, a cursor) for indicating a range of a stereoscopic image in one image is displayed in addition to the at least one image (for example, an image at a left viewpoint) (for example, making the marking superimposed on the image at the left viewpoint) in two or more images by viewpoints.

Hence, it becomes possible to grasp easily a range of a stereoscopic image in at least one image (for example, an image at a left viewpoint) of two or more images by viewpoints.

An invention according to a fourth aspect is a compound eye digital camera which is equipped with two or more image pickup devices corresponding to two or more viewpoints, comprising: a creation device which not only creates as real images two or more images by viewpoints photographed by the image pickup devices, a stereoscopic image including a common image range cut from the images by viewpoints, and a whole image synthesized from the images by viewpoints, but also creates two or more thumbnail images by viewpoints corresponding to each of the images by viewpoints respectively, a stereoscopic thumbnail image corresponding to the stereoscopic image, and a whole thumbnail image corresponding to the whole image; a thumbnail image display device which displays a thumbnail image belonging to at least one kind among the thumbnail images by viewpoints, the stereoscopic thumbnail image, and the whole thumbnail image; a switching device which switches a kind of a thumbnail image displayed by the display device; a selection device which makes a desired thumbnail image selected among from thumbnail images displayed by the display device; a real image display device which displays a real image corresponding to the thumbnail image selected by the selection device; an edit device which edits a range of the stereoscopic image; and a stereoscopic thumbnail image creation device which creates and changes a stereoscopic thumbnail image corresponding to the stereoscopic image after the edit.

According to the invention according to the fourth aspect, two or more real images (in the case of two viewpoints, a total of four real images of a real image at a right viewpoint, a real image at a left viewpoint, a stereoscopic image, and a whole image), and two or more thumbnail images (in the case of two viewpoints, a total of four thumbnail images of a thumbnail image at a right viewpoint, a thumbnail image at a left viewpoint, a stereoscopic thumbnail image, and a whole thumbnail image) are created, and they are recorded as, for example, an image file in a predetermined image format.

That is, real images, thumbnail images, and the like, which are classified by the viewpoint, besides a stereoscopic image and a stereoscopic thumbnail image are also recorded.

Hence, as the conventional, even if a portion necessary as a 3D image remains by editing and an image in a portion which does not contribute to 3D display is discarded, it is possible to display a real image, a thumbnail image, and the like, which are classified by the viewpoint, besides a stereoscopic image and a stereoscopic thumbnail image, and hence, it becomes possible to easily search a subject photographed in an image portion and the like in an edge not appearing in 3D display.

In addition, since an edit device which edits a range of a stereoscopic image is provided, it becomes possible to edit an image range where beautiful stereoscopic vision is obtained (it seems to be so) with avoiding an area adversely affected to control of a stereoscopic effect and display of a good stereoscopic image such as a main object and a background.

An invention according to a fifth aspect is an image management method which creates and records two or more real images and two or more thumbnail images from two or more images by viewpoints photographed by two or more image pickup devices corresponding to the viewpoints, comprising: a step of performing photographing by the image pickup devices; a step of creating the images by viewpoints and two or more thumbnail images by viewpoints corresponding to the images by viewpoints respectively; a step of designating a range which is stereoscopically displayable from the images by viewpoints, cutting out an image corresponding to the designated range as a stereoscopic image from the image by viewpoints, and creating a stereoscopic thumbnail image corresponding to the stereoscopic image; a step of creating a whole image synthesized from the images by viewpoints, and a whole thumbnail image corresponding to the whole image; and a step of recording the images by viewpoints, thumbnail image by viewpoints, the stereoscopic image, the stereoscopic thumbnail image, the whole image, and the whole thumbnail image, which are created at the respective steps, on a recording medium.

According to the invention according to the fifth aspect, from the two or more images by viewpoints photographed by two or more image pickup devices corresponding to two or more viewpoints (for example, two viewpoints), two or more real images (in the case of two viewpoints, a total of four real images of a real image at a right viewpoint, a real image at a left viewpoint, a stereoscopic image, and a whole image), and two or more thumbnail images (in the case of two viewpoints, a total of four thumbnail images of a thumbnail image at a right viewpoint, a thumbnail image at a left viewpoint, a stereoscopic thumbnail image, and a whole thumbnail image) are created, and they are recorded as, for example, an image file in a predetermined image format.

That is, real images, thumbnail images and the like, which are classified by the viewpoint (thumbnail images by viewpoints), besides a stereoscopic image and a stereoscopic thumbnail image are also recorded.

Hence, as the conventional, even if a portion necessary as a 3D image remains by editing and an image in a portion which does not contribute to 3D display is discarded, it is possible to display a real image, a thumbnail image by viewpoints, besides a stereoscopic image and a stereoscopic thumbnail image, and hence, it becomes possible to search easily a subject photographed in an image portion and the like in an edge not appearing in 3D display.

An invention according to a sixth aspect is an image reproducing method, which reproduces two or more images by viewpoints photographed by two or more image pickup devices corresponding to the viewpoints, comprising: a step of reading and displaying a thumbnail image belonging to at least one kind among thumbnail images by viewpoints corresponding to the images by viewpoints respectively, a stereoscopic thumbnail image corresponding to a stereoscopic image cut out from the images by viewpoints in a stereoscopically displayable range, and a whole thumbnail image corresponding to a whole image synthesized from the images by viewpoints; a step of switching a kind of the thumbnail image displayed; a step of reading and displaying a thumbnail image belonging to the kind which is switched; a step of making a desired thumbnail image selected among from the thumbnail images displayed; and a step of displaying a real image corresponding to the thumbnail image selected.

According to the invention according to the sixth aspect, it becomes possible to display a real image of a selected thumbnail image by reading and displaying thumbnail images by viewpoints (in the case of two viewpoints, a right viewpoint thumbnail image and a left viewpoint thumbnail image), and a stereoscopic thumbnail image or a thumbnail image belonging to at least one kind in the whole thumbnail image, and switching the kind of this displayed thumbnail image to select a desired thumbnail image.

Hence, as the conventional, even if a portion necessary as a 3D image remains by editing and an image in a portion which does not contribute to 3D display is discarded, it is possible to display not only a stereoscopic thumbnail image, but also thumbnail images by viewpoints and the like besides a stereoscopic thumbnail image with switching them, and hence, it becomes possible to search easily a subject photographed in an image portion and the like in an edge not appearing in 3D display.

An invention according to a seventh aspect is an image reproducing method, which reproduces two or more images by viewpoints photographed by two or more image pickup devices corresponding to the viewpoints, comprising: a step of reading and displaying a thumbnail image belonging to at least one kind among thumbnail images by viewpoints corresponding to the images by viewpoints respectively, a stereoscopic thumbnail image corresponding to a stereoscopic image cut out from the images by viewpoints in a stereoscopically displayable range, and a whole thumbnail image corresponding to a whole image synthesized from the images by viewpoints; a step of making a thumbnail image to be edited, selected from the thumbnail images displayed; a step of displaying a stereoscopic image corresponding to the thumbnail image selected; a step of editing a range of the stereoscopic image displayed; a step of creating and changing a stereoscopic thumbnail image corresponding to the stereoscopic image after the edit; and a step of recording the stereoscopic image and the stereoscopic thumbnail image after the edit on a recording medium.

According to the invention according to the seventh aspect, since a step of editing a range of a stereoscopic image is provided, it becomes possible to edit an image range where beautiful stereoscopic vision is obtained (it seems to be so) with avoiding an area adversely affected to control of a stereoscopic effect to the stereoscopic image display of a main object and a background, etc.

According to the present invention, it becomes possible to search easily a subject photographed in an image portion and the like in an edge not appearing at 3D display.

### BRIEF DESCRIPTION OF THE DRAWINGS

FIG. 1 is a front perspective view showing external construction of a digital camera according to a first embodiment of the present invention;

FIG. 2 is a back perspective view showing external construction of the digital camera according to the first embodiment of the present invention;

FIG. 3 is a block diagram showing electric constitution of the digital camera 10 shown in FIGS. 1 and 2;

FIG. 4 is a block diagram showing schematic construction of digital signal processing units 142R and 142L;

FIGS. 5A to 5D are diagrams for describing examples of real images;

FIG. 6 is a diagram for describing that a left-leaning image from the image pickup device R and a right-leaning image from the image pickup device L are obtained;

FIGS. 7A to 7D are diagrams for describing thumbnail images;

FIG. 8 is a diagram for describing an example of a cursor;

FIG. 9 is a diagram for describing an example of a marking which displays to which range of a whole image a stereoscopic image, or a left viewpoint or right view image corresponds;

FIG. 10 is a drawing for describing hierarchy of a directory where image files are recorded;

FIG. 11 is an example of an image format;

FIG. 12 is a flowchart for describing an operation (operation at the time of photographing) of the digital camera 10 of the first embodiment;

FIG. 13 is a flowchart for describing an operation (operation at the time of reproduction) of the digital camera 10 of the first embodiment;

FIG. 14 is a flowchart for describing an operation (operation at the time of edit) of the digital camera 10 of the first embodiment;

FIGS. 15A to 15D are examples of display switching of thumbnail images;

FIGS. 16A to 16D are other examples of display switching of thumbnail images;

FIGS. 17A to 17D are display examples of real images after thumbnail image selection;

FIGS. 18A and 18B are other display examples of real images;

FIG. 19 is an example of a screen displayed at the time of editing;

FIG. 20 is an example of key arrangement of a camera; and

FIG. 21 is a diagram for describing a mechanism which enables stereoscopic vision display on a monitor 24.

### DETAILED DESCRIPTION OF THE PREFERRED EMBODIMENTS

Hereafter, a digital camera (photographing apparatus) which is a first embodiment of the present invention will be described with referring to drawings.

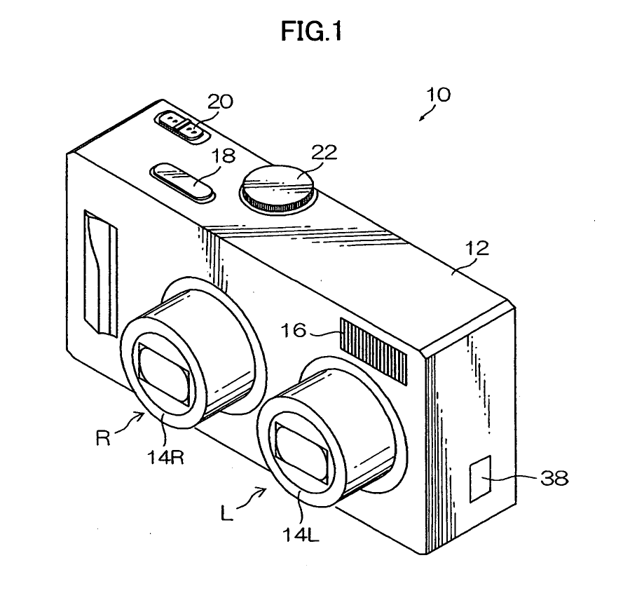

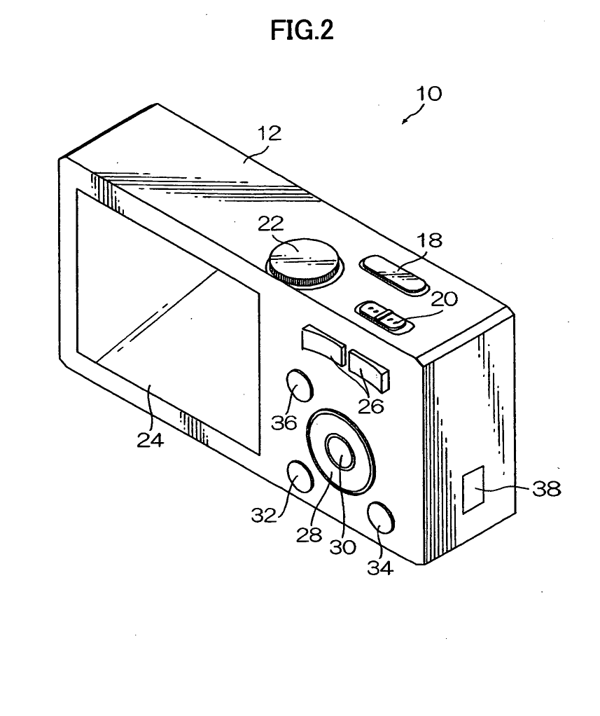

FIG. 1 is a front perspective view showing external construction of the digital camera which is the first embodiment of the present invention. FIG. 2 is a back perspective view showing external construction of the digital camera which is the first embodiment of the present invention.

A digital camera 10 of this embodiment is a digital camera equipped with two or more (equivalent to a compound eye digital camera of the present invention) (two devices are shown in FIG. 1 as an example) image pickup devices (these are also called image pickup systems), and can photograph the same subject from two or more viewpoints (two of right and left viewpoints are shown in FIG. 1 as an example).

In addition, in this embodiment, although two image pickup devices are shown as an example for the facilities of a description, the present invention is not limited to this. Even if they are three or more image pickup devices, the present invention is applicable similarly. Furthermore, layout of image pickup devices (mainly image taking lens) may not be in one row, but may be placed two-dimensionally. Stereography or multi-viewpoint or omnidirectional photographing may be sufficient.

A camera body 12 of the digital camera 10 is formed in a rectangular box shape, and a pair of image taking lenses 14R and 14L, a strobe 16, and the like are provided in its front as shown in FIG. 1. In addition, a shutter button 18, a power supply/mode switch 20, a mode dial 22, and the like are provided in a top face of the camera body 12.

On the other hand, a monitor 24, a zoom button 26, a cross button 28, a MENU/OK button 30, a DISP button 32, a BACK button 34, a macro button 36, and the like are provided in a back face of the camera body 12 as shown in FIG. 2.

In addition, although not illustrated, a tripod screw hole, a battery cover which can be opened and closed freely, and the like are provided in a bottom face of the camera body 12, and a battery storage chamber for containing a battery, a memory card slot for mounting a memory card, and the like are provided inside the battery cover.

The pair of right and left image taking lenses 14R and 14L each are constructed of a collapsible mount type zoom lens, and have a macro photographing function (close photographing function). These image taking lenses 14R and 14L protrude from the camera body 12 respectively when a power supply of the digital camera 10 is turned on.

In addition, about the zoom mechanism, a collapsing mechanism, and a macro photographing mechanism in an image taking lens, since they are publicly-known techniques, descriptions about their specific construction will be omitted here.

The strobe 16 is constructed of a xenon tube and emits light if needed, that is, in the case of photographing of a dark subject, a backlit subject, or the like.

The shutter button 18 is constructed of a two-step stroke type switch whose functions are so-called “half press” and “full press.” When this shutter button 18 is half-pressed at the time of still image photographing (for example, at the time of selecting a still image photographing mode with the mode dial 22, or selecting the still image photographing mode from a menu), the digital camera 10 performs photographing preparation process, that is, respective processing of AE (Automatic Exposure), AF (Auto Focus), and AWB (Automatic White Balance), and when fully-pressed, it performs photographing and recording processing of an image. In addition, when this shutter button 18 is fully-pressed at the time of moving image photographing (for example, at the time of selecting a moving image photographing mode with the mode dial 22, or at the time of selecting the moving image photographing mode from a menu), photographing of moving images is started, and the photographing is completed when it is fully presses again. In addition, depending on setup, it is possible to perform photographing of moving images for the shutter button 18 being fully pressed, and to complete photographing when full press is released. Furthermore, it is also sufficient to provide a shutter button only for still image photographing, and a shutter button only for moving image photographing.

While functioning as a power switch of the digital camera 10, the power supply/mode switch 20 functions as a switching device which switches a reproduction mode and a photographing mode of the digital camera 10, and is provided slidably among an “OFF position”, a “reproduction position”, and a “photographing position.” When this power supply/mode switch 20 is located in the “reproduction position”, the digital camera 10 is set in the reproduction mode, and when being located in the “photographing position”, it is set in the photographing mode. Moreover, the power supply is turned off when the switch is located in the “OFF position.”

The mode dial 22 is used for setting the photographing mode. This mode dial 22 is rotatably provided in a top face of the camera body 12, and is provided settably in a “2D still image position”, a “2D moving image position”, a “3D still image position”, and a “3D moving image position” by a click mechanism which is not shown. The digital camera 10 is set in the 2D still image photographing mode, in which a 2D still image is photographed, by this mode dial 22 being set in the “2D still image position”, and a flag which indicates that it is in the 2D mode is set in a 2D/3D mode switching flag 168. In addition, by this mode dial 22 being set in the “2D moving image position”, the digital camera 10 is set in the 2D moving image photographing mode in which 2D moving images are photographed, and a flag which indicates that it is in the 2D mode is set in the 2D/3D mode switching flag 168.

In addition, by the mode dial 22 being set in the “3D still image position”, the digital camera 10 is set in the 3D still image photographing mode in which a 3D still image is photographed, and a flag which indicates that it is in the 3D mode is set in the 2D/3D mode switching flag 168. Furthermore, by the mode dial 22 being set in the “3D moving image position”, the digital camera 10 is set in the 3D moving image photographing mode in which 3D moving images are photographed, and a flag which indicates that it is in the 3D mode is set in a 2D/3D mode switching flag 168. A CPU 110 mentioned later grasps which of the 2D mode or 3D mode is set in with reference to this 2D/3D mode switching flag 168.

The monitor 24 is a display apparatus, such as a color liquid crystal panel, in which a so-called lenticular lens which has a semicylindrical lens group is placed in its front face. This monitor 24 is used as a GUI at the time of various setups while used as an image display unit for displaying a photographed image. In addition, at the time of photographing, it is used as an electronic finder on which an image caught with an image pickup element is given pass-through display (real-time display).

Here, a mechanism that stereoscopic vision display becomes possible on the monitor 24 will be described with referring to drawings.

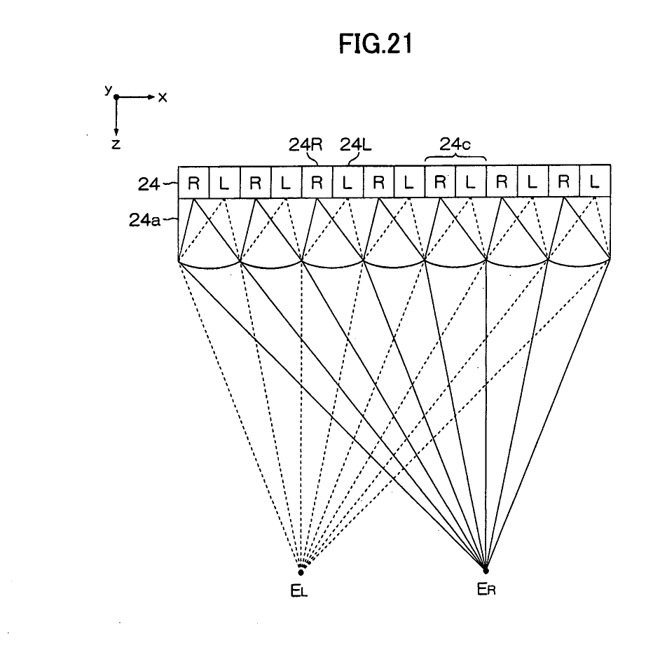

FIG. 21 is a diagram for describing a mechanism which enables stereoscopic vision display on a monitor 24. A lenticular lens 24a is placed in a front face of the monitor 24 (a z axial direction in which view person's viewpoints (left eye EL, and right eye ER) exist). The lenticular lens 24a is constructed by putting two or more cylindrical convex lenses in a row in an x axial direction in FIG. 21.

A display area of a stereoscopic vision image displayed on the monitor 24 is constructed of rectangular image display areas 24R for a right eye, and rectangular image display areas 24L for a left eye. The rectangular image display areas 24R for a right eye and the rectangular image display areas 24L for a left eye each have a shape of a long and slender rectangle (reed-shape) in a y axial direction of a screen in FIG. 21, and are placed by turns in the x axial direction in FIG. 21.

Each convex lens of the lenticular lens 24a is formed in a position corresponding to a rectangular collecting image display area 24c, including a set of rectangular image display area 24R for a right eye and rectangular image display area 24L for a left eye, on the basis of an observer's given viewpoint.

Rectangular images for a right eye displayed on the rectangular image display areas 24R for a right eye in monitor 24 are incident into a right eye ER of an observer with an optical refractive action of the lenticular lens 24a in FIG. 21. In addition, rectangular images for a left eye displayed on the rectangular image display areas 24L for a left eye in monitor 24 are incident into a left eye EL of the observer with the optical refractive action of the lenticular lens 24a. Hence, since the right eye of the observer observes only the rectangular images for a right eye, and the left eye of the observer observes only the rectangular images for a left eye, stereoscopic vision becomes possible by right and left parallax by an image for a right eye which is a set of rectangular images for a right eye, and an image for a left eye which is a set of rectangular images for a left eye.

In addition, the monitor 24 includes display elements, which can display both of two-dimensional and three-dimensional images, such as liquid crystal elements, or organic EL elements. The monitor 24 may have such a system that there is spontaneous light or a light source independently, and light quantity is controlled. Furthermore, it may have any system, such as a system by polarization, an anaglyph, and a naked eye system. In addition, it may have a system that liquid crystal elements or organic EL elements are overlapped in a multilayer.

The zoom button 26 is used for a zoom operation of the photographing lenses 14R and 14L, and is constructed of a tele-zoom button which instructs a zoom to a telephoto side, and a wide-zoom button which instructs a zoom to a wide-angle side.

The cross button 28 is provided with being pressable in four directions of up, down, left, and right directions, and a function according to a set state of the camera is assigned to a button in each direction. For example, at the time of photographing, a function of switching ON/OFF of a macro function is assigned to a left button, and a function of switching a strobe mode is assigned to a right button. In addition, a function of changing brightness of the monitor 24 is assigned to an up button, and a function of switching ON/OFF of a self-timer is assigned to a down button. In addition, at the time of reproduction, a function of frame advance is assigned to the left button and a function of frame back is assigned to the right button. In addition, a function of changing brightness of the monitor 24 is assigned to the up button, and a function of deleting a reproducing image is assigned to the down button. In addition, at the time of various setups, a function of moving a cursor displayed on the monitor 24 in a direction of each button is assigned.

The MENU/OK button 30 is used for decision of selection content, an execution instruction (O.K. function) of processing, and the like while being used for a call (MENU function) of a menu screen, and an assigned function is switched according to the set state of the digital camera 10.

On the menu screen, setup of all the adjustment items which the digital camera 10 has is performed, all the adjustment items including an exposure value, a tint, ISO speed, picture quality adjustment such as a record pixel count, setup of the self-timer, switching of a metering system, use/no use of digital zoom, and the like. The digital camera 10 operates according to a condition set on this menu screen.

The DISP button 32 is used for an input of a switching instruction of display content of the monitor 24, and the like, and the BACK button 34 is used for an input of an instruction such as cancellation of input operation.

The portrait/landscape switching button 36 is a button for instructing in which of a portrait mode and a landscape mode photographing is performed. The portrait/landscape detecting circuit 166 detects in which of a portrait mode and a landscape mode photographing is performed, from a state of this button.

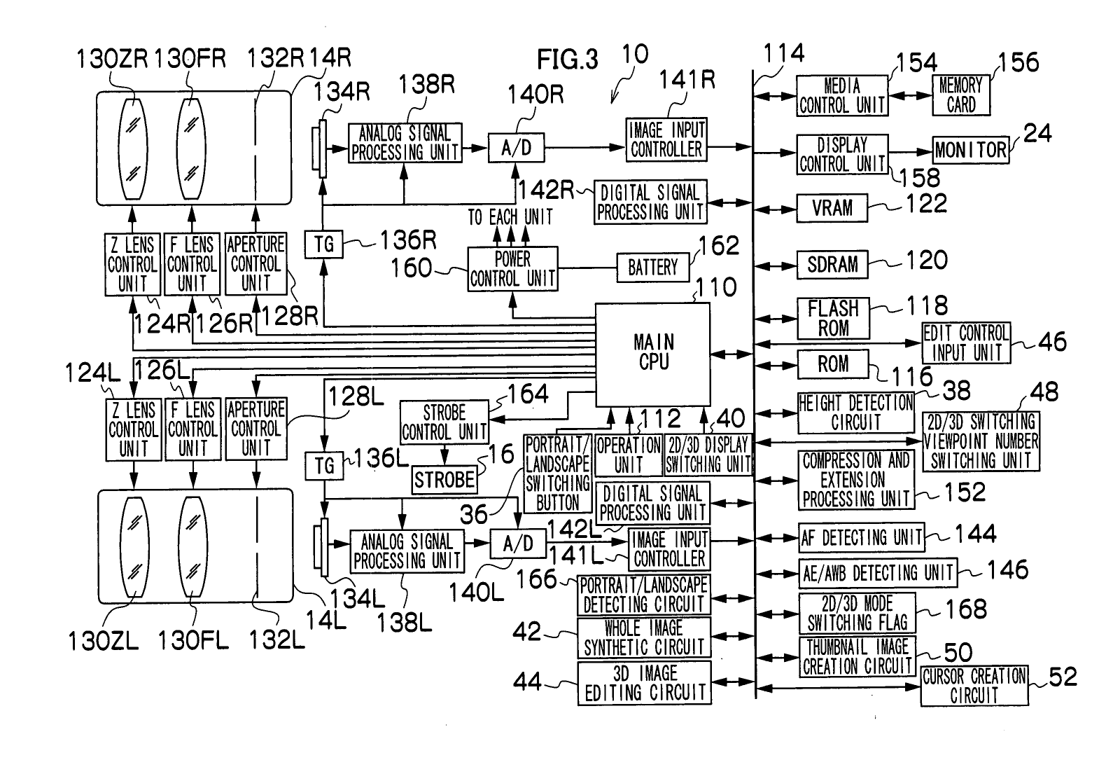

FIG. 3 is a block diagram showing electric constitution of the digital camera 10 shown in FIGS. 1 and 2.

As shown in FIG. 3, the digital camera 10 of this embodiment is constructed so as to acquire an image signal from each of two image pickup systems, and is equipped with a CPU 110, a 2D/3D display switching unit 40, a whole image synthetic circuit 42, a 3D image editing circuit 44, an edit control input unit 46, a 2D/3D switching viewpoint number switching unit 48, a thumbnail image creation circuit 50, a cursor creation circuit 52, an operation unit (a shutter button 18, a power supply/mode switch 20, a mode dial 22, a zoom button 26, a cross button 28, a MENU/OK button 30, a DISP button 32, a BACK button 34, a 2D/3D mode switching button 36, and the like) 112, ROM 116, flash ROM 118, SDRAM 120, VRAM 122, image taking lenses 14R and 14L, zoom lens control units 124R and 124L, focus lens control units 126R and 126L, aperture control units 128R and 128L, image pickup elements 134R and 134L, timing generators (TG) 136R and 136L, analog signal processing units 138R and 138L, A/D converters 140R and 141L, image input controllers 141R and 141L, digital signal processing units 142R and 142L, an AF detecting unit 144, an AE/AWB detecting unit 146, a 3D image generation unit 150, a compression and extension processing unit 152, a media control unit 154, a memory card 156, a display control unit 158, a monitor 24, a power control unit 160, a battery 162, a strobe control unit 164, a strobe 16, and the like.

An image pickup device R in a right-hand side in FIG. 1 is mainly constructed of the image taking lens 14R, zoom lens control unit 124R, focus lens control unit 126R, aperture control unit 128R, image pickup element 134R, timing generator (TG) 136R, analog signal processing unit 138R, A/D converter 140R, image input controller 141R, and digital signal processing unit 142R, etc.

An image pickup device L in a left-hand side in FIG. 1 is mainly constructed of the image pickup lens 14L, zoom lens control unit 124L, focus lens control unit 126L, aperture control unit 128L, image pickup element 134L, timing generator (TG) 136L, analog signal processing unit 138L, A/D converter 140L, image input controller 141L, and digital signal processing unit 142L, etc.

The CPU 110 functions as a control device which performs integrated control of operations of a whole camera, and, controls each unit according to a predetermined control program on the basis of an input from the operation unit 112.

The ROM 116 connected through a bus 114 stores a control program, which this CPU 110 executes, various data (an AE/AF control period and the like which are mentioned later) necessary for control, and the like, and flash ROM 118 stores various setup information regarding operations of the digital cameras 10, such as user setup information, etc.

While being used as a calculation work area of the CPU 110, the SDRAM 120 is used as a temporary storage of image data, and the VRAM 12 is used as a temporary storage dedicated for image data for a display.

A pair of right and left photographing lenses 14R and 14L is constructed by including zoom lenses 130ZR and 130ZL, focus lenses 130 FR and 130FL, and apertures 132R and 132L, and are placed with a predetermined gap in the camera body 12.

The zoom lenses 130ZR and 130ZL are driven by zoom actuators not shown, and move back and forth along an optical axis. The CPU 110 controls positions of the zoom lenses by controlling drive of the zoom actuators through the zoom lens control units 124R and 124L, and performs zooming of the photographing lenses 14R and 14L.

The focus lenses 130FR and 130FL are driven by focus actuators not shown, and move back and forth along the optical axis. The CPU 110 controls positions of the focus lenses by controlling drive of the focus actuators through the focus lens control units 126R and 126L, and performs focusing of the photographing lenses 14R and 14L.

The apertures 132R and 132L are constructed of iris stops, and are driven by aperture actuators, not shown, to operate, for example. The CPU 110 controls opening amounts (f-stop numbers) of the apertures 132R and 132L by controlling drive of aperture actuators through the aperture control units 128R and 128L, and controls incident light quantity into the image pickup elements 134R and 134L.

In addition, the CPU 110 drives the right and left photographing lenses 14R and 14L synchronously when driving the zoom lenses 130ZR and 130ZL, focus lenses 130FR and 130FL, and apertures 132R and 132L which construct these photographing lenses 14R and 14L. That is, the right and left photographing lenses 14R and 14L are set at the always same focal length (zoom magnifying power) for focusing to be performed so that the always same subject may be focused. In addition, the apertures are adjusted so as to become the always same incident light quantity (f-stop number).

The image pickup elements 134R and 134L each are constructed of a color CCD with a predetermined color filter array. As for a CCD, many photodiodes are arranged two-dimensionally on its light-receiving surface. Optical images of a subject which are imaged on light-receiving surfaces of CCDs by the photographing lenses 14R and 14L are converted into signal charges according to incident light quantity by these photodiodes. The signal charges stored in respective photodiodes are sequentially read from the image pickup elements 134R and 134L one by one as voltage signals (image signals) corresponding to the signal charges on the basis of driving pulses given by the TGs 136R and 136L according to a command of the CPU 110.

In addition, since these image pickup elements 134R and 134L each are equipped with a function of electronic shutter, exposure time (shutter speed) is controlled by controlling charge storage time to the photodiodes.

Furthermore, in this embodiment, although CCDs are used as image pickup elements, image pickup elements with other constructions, such as CMOS sensors, can be also used.

The analog signal processing units 138R and 138L each include a correlation double sampling circuit (CDS) for removing reset noise (low frequency) included in each of the image signals outputted from the image pickup elements 134R and 134L, and an AGS circuit for amplifying an image signal and controls it in a constant level of amplitude, and hence, amplify each of the image signals outputted from the image pickup elements 134R and 134L while performing correlation double sampling processing.

The A/D converters 140R and 140L convert into digital image signals the analog image signals outputted from the analog signal processing units 138R and 138L.

The image input controllers 141R and 141L fetch the image signals outputted from the A/D converters 140R and 140L to store them in the SDRAM 120.

The digital signal processing units 142R and 142L fetch the image signals stored in the SDRAM 120 according to a command from the CPU 110, and give predetermined signal processing to them to generate a YUV signal which is constructed of a luminance signal Y and color-difference signals Cr and Cb.

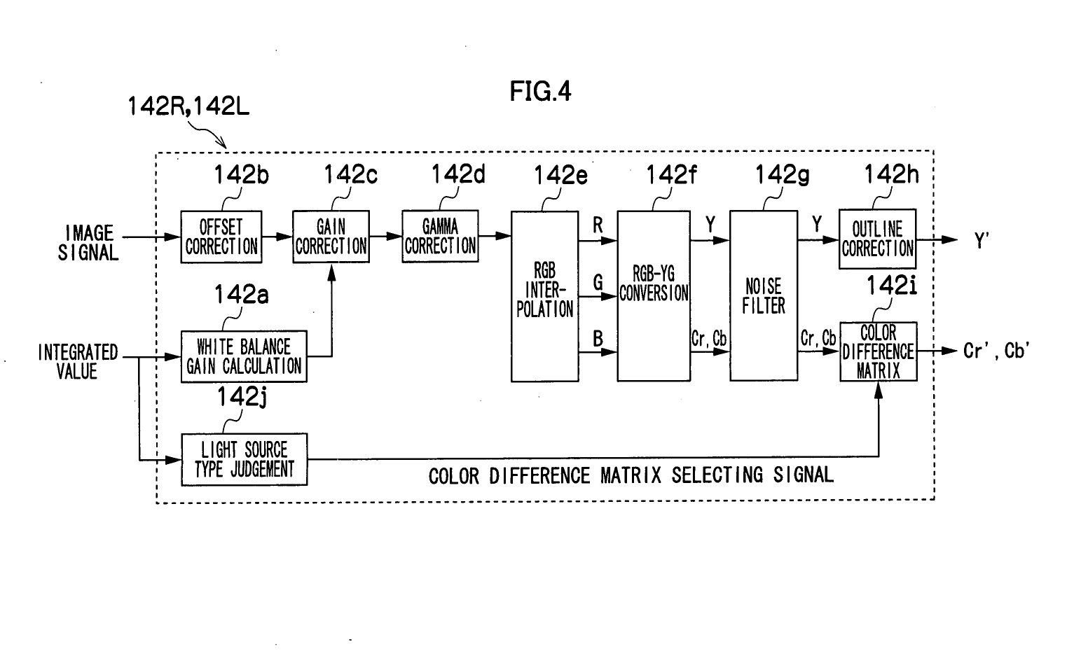

FIG. 4 is a block diagram showing schematic construction of these digital signal processing units 142R and 142L.

As shown in FIG. 4, the digital signal processing units 142R and 142L each are constructed by being equipped with a white balance gain calculation circuit 142a, an offset correcting circuit 142b, a gain correction circuit 142c, a gamma correction circuit 142d, an RGB interpolating calculation unit 142e, an RGB/YC conversion circuit 142f, a noise filter 142g, a contour correction circuit 142h, a color difference matrix circuit 142i, and a light source type judging circuit 142j.

The white balance gain calculation circuit 142a fetches an integrated value calculated in the AE/AWB detecting unit 146 to calculate a gain value for white balance adjustment.

The offset correcting circuit 142b performs offset processing to an image signal of each color of R, G, and B which are fetched through the image input controllers 141R and 141L.

The gain correction circuit 142c fetches the image signal which is given offset processing to perform white balance adjustment using the gain value calculated in the white balance gain calculation circuit 142a.

The gamma correction circuit 142d fetches the image signal which is given the white balance adjustment to perform gamma correction using a predetermined gamma value.

The RGB interpolating calculation unit 142e performs interpolating calculation of chrominance signals of R, G, and B which are given gamma correction to find three color signals of R, G, and B in respective picture element positions. That is, since only a signal of one color out of R, G, and B is outputted from each pixel in the case of a single plate-type image pickup element, colors which are not outputted are obtained by interpolating calculation from chrominance signals of surrounding pixels. For example, in a pixel which outputs R, how large chrominance signals of G and B in this pixel position become is obtained by the interpolating calculation from G and B signals of surrounding pixels. In this way, since the RGB interpolating calculation is peculiar to a single plate-type image pickup element, when a 3 plate type image pickup element 134 is used, it becomes unnecessary.

The RGB/YC conversion circuit 142f generates a luminance signal Y and color-difference signals Cr and Cb from R, G, and B signals after the RGB interpolating calculation.

The noise filter 142g performs noise reduction processing to the luminance signal Y and color-difference signals Cr and Cb which are generated by the RGB/YC conversion circuit 142f.

The contour correction circuit 142h performs contour correction processing to the luminance signal Y after noise reduction, and outputs a luminance signal Y′ given the contour correction.

On the other hand, the color difference matrix circuit 142i performs multiplication of a color difference matrix (C-MTX) to the color-difference signals Cr and Cb after noise reduction to perform color correction. That is, the color difference matrix circuit 142i has two or more kinds of color difference matrices corresponding to light sources, switches color difference matrices to be used according to a kind of a light source which the light source type judging circuit 142j finds, and multiplies the inputted color-difference signals Cr and Cb by the color difference matrix after this switching to output color-difference signals Cr′ and Cb′ which are given color correction.

The light source type judging circuit 142j fetches the integrated value calculated in the AE/AWB detecting unit 146, judges a light source type, and outputs a color difference matrix selecting signal to the color difference matrix circuit 142i.

In addition, although the digital signal processing unit is constructed in hardware circuits in the digital camera of this embodiment as described above, it is also possible to construct in software the same function as the hardware circuits concerned.

The AF detecting unit 144 fetches an image signal of each color of R, G, and B which are fetched from one side of image input controller 141R, and calculates a focal point evaluation value necessary for AF control. This AF detecting unit 144 includes a high-pass filter which passes only a high frequency component of a G signal, an absolute value conversion processing unit, a focusing area extraction unit which cuts out a signal in a predetermined focusing area set on a screen, and an accumulation unit which integrates absolute value data in the focusing area, and outputs the absolute value data in the focusing area, which is integrated in this accumulation unit, to the CPU 110 as a focal point evaluation value.

The CPU 110 performs focusing to a main subject by searching a position where the focal point evaluation value outputted from this AF detecting unit 144 becomes at local maximum and moving the focus lenses 130FR and 130FL to the position at the time of AF control. That is, at the time of AF control, first, the CPU 110 moves the focus lenses 130FR and 130FL from the close to the infinite, and acquires the focal point evaluation value from the AF detecting unit 144 serially during the moving process to detect the position where the focal point evaluation value becomes at local maximum. Then, it judges that the position where the detected focal point evaluation value is at local maximum is a focused position, and moves the focus lenses 130FR and 130FL to the position. Thereby, the subject (main subject) located in focusing area is focused.

The AE/AWB detecting unit 146 fetches an image signal of each color of R, G, and B which are fetched from one side of image input controller 141R, and calculates an integrated value necessary for AE control and AWB control. That is, this AE/AWB detecting unit 146 divides one screen into two or more areas (for example, 8×8=64 areas), and calculates the integrated value of R, G, and B signals for every divided area.

At the time of AE control, the CPU 110 acquires the integrated value of R, G, and B signals for every area which is calculated in this AE/AWB detecting unit 146, and obtains brightness (photometric value) of the subject to perform exposure setting for obtaining proper exposure. That is, it sets sensitivity, an f-stop number, shutter speed, and necessity of strobe light.

In addition, the CPU 110 applies the integrated value of R, G, and B signals for every area, which is calculated in the AE/AWB detecting unit 146, to the white balance gain calculation circuit 142a and light source type judging circuit 142j of the digital signal processing unit 142 at the time of AWB control.

The white balance gain calculation circuit 142a calculates a gain value for white balance adjustment on the basis of this integrated value calculated in the AE/AWB detecting unit 146.

In addition, the light source type judging circuit 142j detects a light source type on the basis of this integrated value calculated in the AE/AWB detecting unit 146.

The compression and extension processing unit 152 gives compression processing in a predetermined format to the inputted image data according to a command from the CPU 110 to generate compressed image data. Furthermore, the compression and extension processing unit 152 gives extension processing in a predetermined format to the inputted compressed image data according to a command from the CPU 110 to generate uncompressed image data. Moreover, the digital camera 10 of this embodiment performs the compression processing based on the JPEG standard for a still image, and performs the compression processing based on the MPEG2 standard for moving images.

The media control unit 154 controls reading/writing of data to the memory card 156 according to a command from the CPU 110.

The display control unit 158 controls display on the monitor 24 according to a command from the CPU 110. That is, it outputs a predetermined character and drawing information to the monitor 24 while converting the inputted image signal into a video signal (e.g., an NTSC signal, a PAL signal, and a SCAM signal) for displaying it on the monitor 24 according to a command from the CPU 110 and outputting it to the monitor 24.

The power control unit 160 controls power supply from the battery 162 to each unit according to a command from the CPU 110.

The strobe control unit 164 controls light emission of the strobe 16 according to a command from the CPU 110.

The height detecting unit 38 is a circuit for detecting photographing height (distance) from a reference plane (e.g., ground surface).

The portrait/landscape detecting circuit 166 detects whether it is a portrait mode or it is a landscape mode according to a state of the portrait/landscape switching button 36.

A flag which indicates that the camera is in the 2D mode or the 3D mode is set in the 2D/3D mode switching flag 168.

Next, examples of real images photographed by the digital camera 10 with the construction will be described.

### [Examples of Real Images and Thumbnail Images]

When the shutter button 18 is pressed under a state that a 3D photographing mode is set by operation of the mode dial 22, photographing is performed with the image pickup devices R and L, and real images and thumbnail images are obtained from image data obtained by this photographing operation.

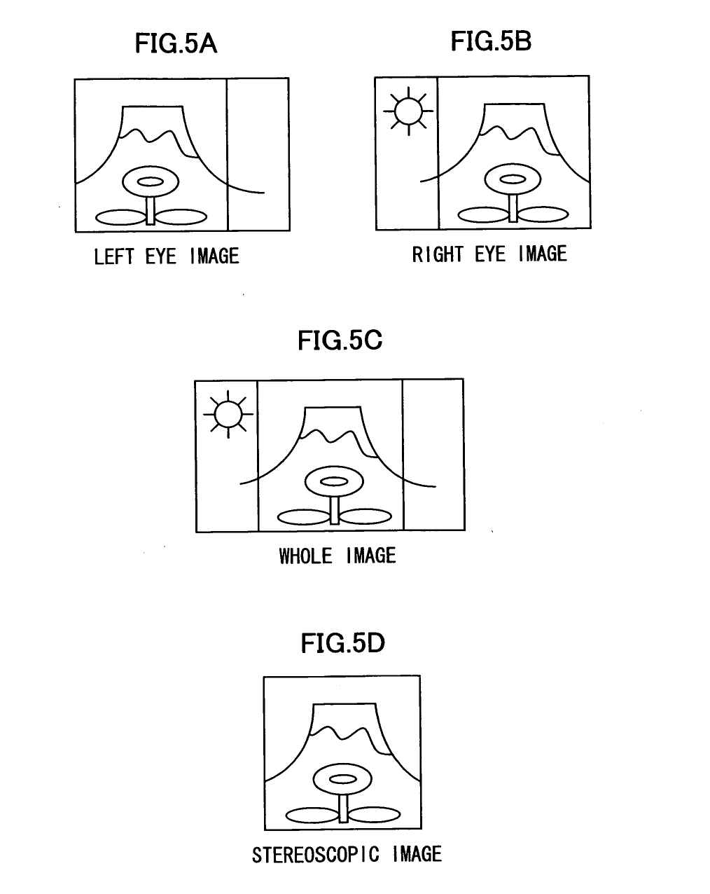

FIGS. 5A to 5D show real images.

FIG. 5A shows a real image at a left viewpoint (hereinafter, a left view image or a left eye image) generated from data of an image photographed by an image pickup device L. FIG. 5B shows a real image at a right viewpoint (hereinafter, a right view image or a right eye image) generated from data of an image photographed by an image pickup device R. FIG. 5C is a real image of a whole image (hereinafter, a whole image) obtained by synthesizing the left view image and right view image. FIG. 5D is an image for making the below-mentioned stereoscopic vision possible (hereinafter, a stereoscopic image or 3D image), and is an image including only an image portion (an area which can be seen stereoscopically) common to the right viewpoint image and left view image. There are the above-mentioned four kinds as real images.

As for how a stereoscopic image is created, it is conceivable, for example, to calculate an area which can be displayed stereoscopically from a distance to a subject, size of the subject, a distance between lenses of the image pickup devices R and L, an angle of convergence, a zoom power, and the like, and to cut the area automatically. Alternatively, it is also conceivable that a camera person adjusts the area with observing a whole image or the like. In addition, a user may adjust an angle of view or a shift amount after photographing.

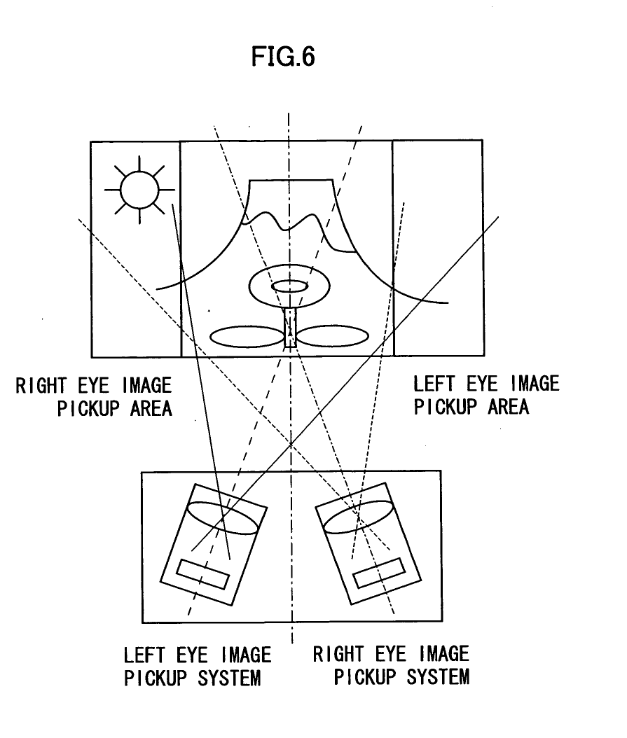

In addition, in the digital camera 10 of this embodiment, since an angle of convergence between the image pickup devices R and L is constructed adjustably as shown in FIG. 6, it is possible to obtain a left-leaning image from the image pickup device R and a right-leaning image from the image pickup device L.

Next, a thumbnail image will be described.

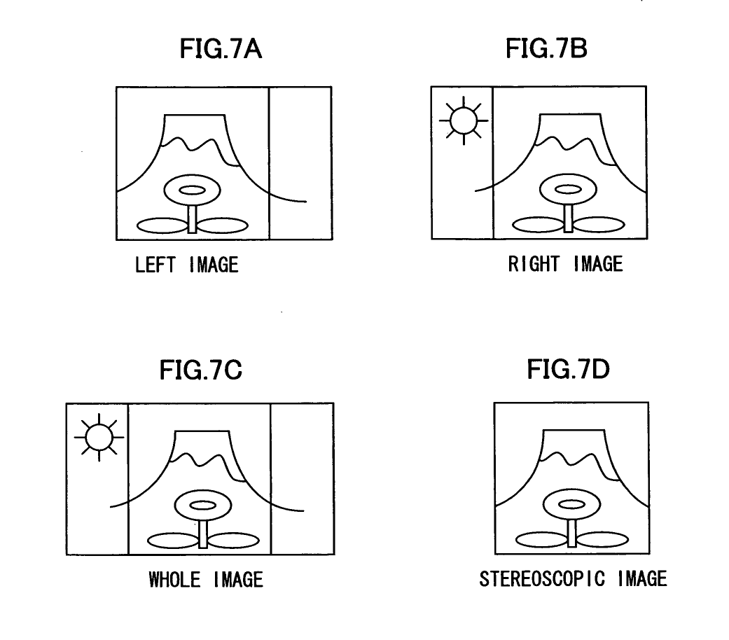

FIGS. 7A to 7D show thumbnail images.

FIG. 7A shows a thumbnail image of the left viewpoint image (hereinafter, a left viewpoint thumbnail image) in FIG. 5A. FIG. 7B shows a thumbnail image of the right viewpoint image (hereinafter, a right viewpoint thumbnail image) in FIG. 5B. FIG. 7C shows a thumbnail image of the whole image (hereinafter, a whole thumbnail image) in FIG. 5C. FIG. 7D shows a thumbnail image of the stereoscopic image (hereinafter, a stereoscopic thumbnail image) in FIG. 5D.

These thumbnail images are created by reducing real images or thinning out pixels under a predetermined rule from real images.

### [Examples of Cursor Display]

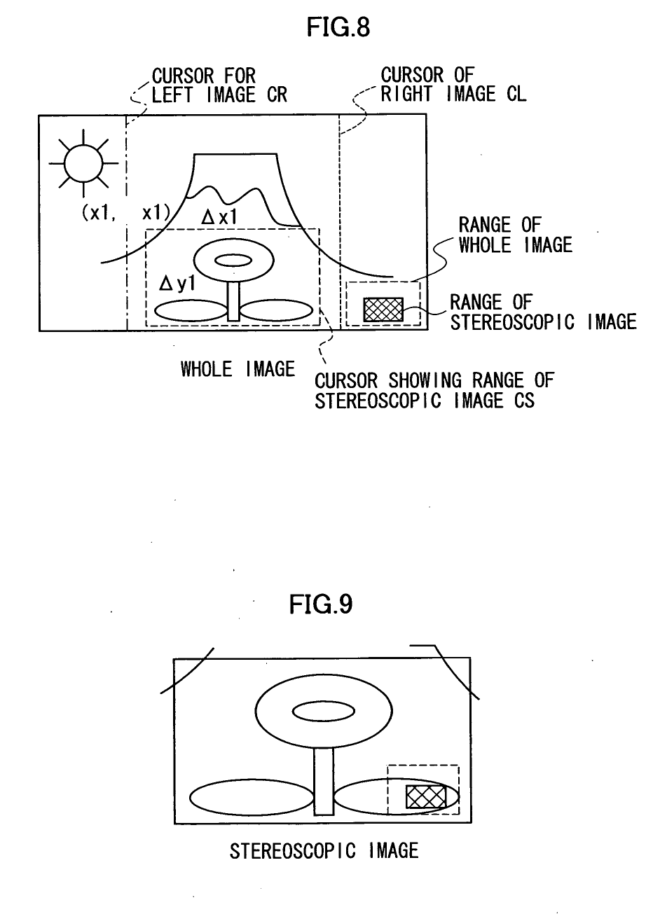

When the whole image shown in FIG. 5C is displayed (reproduction or the like), markings for indicating ranges of the left viewpoint and right viewpoint real images in the whole image identified, and markings for indicating a range of the stereoscopic image in the whole image are displayed with this whole image. FIG. 8 shows an example of the case that these markings are cursors CR (in the figure, shown by a thin dotted line), CL (in the figure, shown by an alternate long and short dash line), and CS (in the figure, shown by a thick dotted line).

FIG. 8 shows that, since parallax with a distant mountain does not suit for a stereoscopic effect to be spoiled, but a stereoscopic image of only a front flower is reproduced correctly, only the front flower is recorded as a stereoscopic image. Of course, resizing of enlargement or shrinkage may be performed according to a resolution of VGA or HD.

In addition, the cursors CR, CL, and CS are not displayed only on a whole image (real image), but markings for indicating a range of a stereoscopic image may be displayed on a left viewpoint or right viewpoint real image.

Furthermore, it may be also sufficient to perform construction so as to show with display of a frame or an image to what range of a whole image a stereoscopic image, or a left viewpoint or right viewpoint real image corresponds. FIG. 8 shows an example of showing such a marking in the lower right of a whole image by a frame. FIG. 9 shows an example of showing such a marking in the lower right of a stereoscopic image by a frame.

The cursors CR, CL, and CS may be displayed on a whole image, or may be displayed on a thumbnail image.

In this way, since markings (cursors) for indicating ranges of a stereoscopic image and the like are displayed, it becomes possible to grasp easily a range of a stereoscopic image and ranges of right or left viewpoint images in a whole image.

### [Examples of Image Formats]

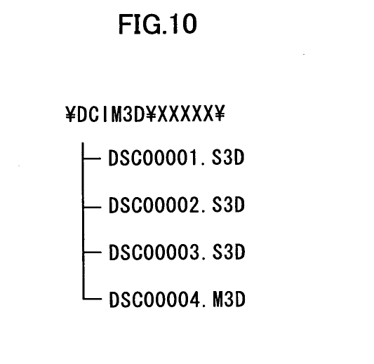

FIG. 10 shows a state that four image files are stored under a directory ¥DCIM3D¥XXXXX¥. An extension S3D shows that its image file is a 3D still image file. The still image is recorded in non compression or in compression by JPEG, JPEG2000, or the like. An extension M3D shows that its image file is a 3D moving image file. In the case of moving images, real images are continuously recorded by a field, a frame, or a block. The moving images are recorded in non compression or in compression by MPEG-2, MPEG-4, H.264 or the like.

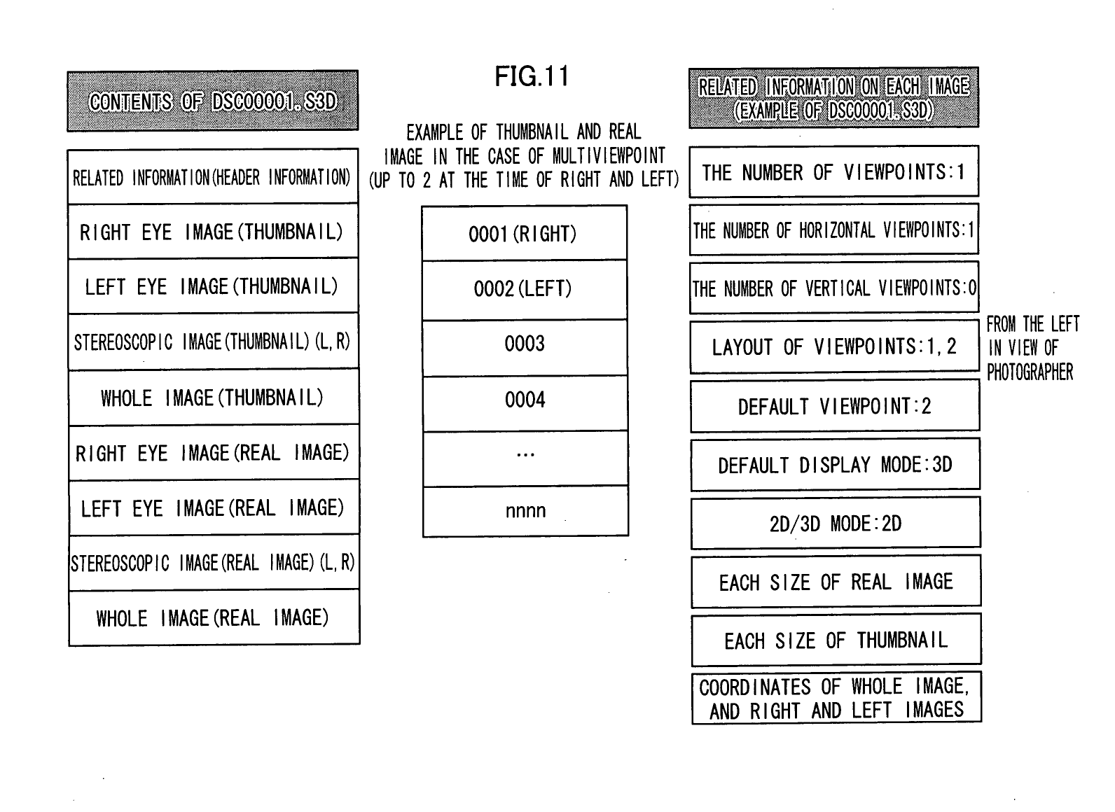

FIG. 11 shows an example of an image format of the file name DSC00001.S3D in FIG. 10.

The image format is constructed of related information (it is also called header information or an image information tag), thumbnails (they are also called thumbnail images), and images (they are also called real images or main images).

The related information is information attached to the real images, and has a viewpoint number field, a horizontal viewpoint number field, a vertical viewpoint number field, a viewpoint layout field, a default viewpoint field, a default display mode field, a 2D/3D mode field, each size field of the real images, each size field of the thumbnails, and a field of coordinates in the whole image, and right and left images.

An identifier for identifying the number of photographing devices which took this image is recorded in the viewpoint number column. An identifier for identifying the number of image pickup devices in the case of using a so-called landscape mode is recorded in the horizontal viewpoint number column. An identifier for identifying the number of image pickup devices in the case of using a so-called portrait mode is recorded in the vertical viewpoint number column.

An identifier for identifying each image pickup device is recorded in order from the left from a camera person's viewpoint in the viewpoint layout column. An identifier for identifying the number of image pickup devices is recorded on the default viewpoint column. A default display mode (2D/3D) is recorded in the default display mode column. An identifier for identifying which of a 2D image and a 3D image a real image is recorded in the 2D/3D mode column.

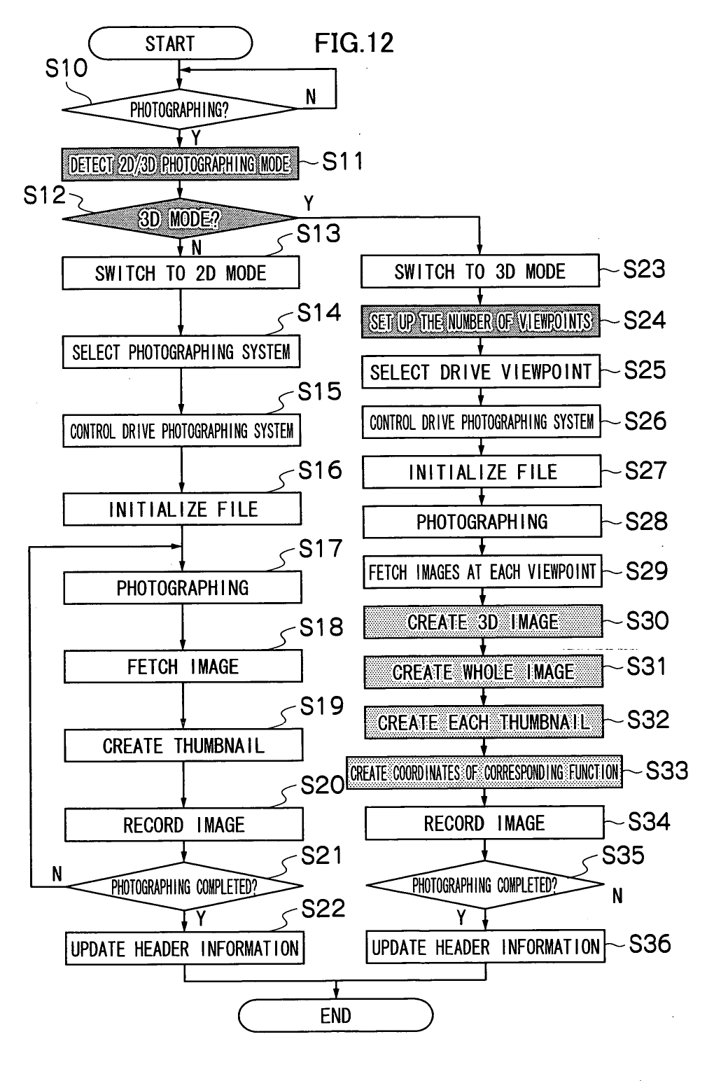

Each size of the real images is recorded on the each size field of the real images. Each size of the thumbnails is recorded on the each size field of the thumbnails. In the field of coordinates in the whole image, and right and left images, information of expressing to which portions in the whole image created at step S31 in FIG. 12, a 3D image created at step S30 in FIG. 12 corresponds (furthermore, information of expressing to which portions in main images at right and left viewpoints the 3D image corresponds), for example, a position, width, and height in the whole image are recorded. The information on this coordinate field makes it possible to express a range of the stereoscopic image, and the like with cursors and the like.

In addition, the related information is not limited to these items. For example, it is also good to record the same items (shutter speed, a lens f-stop number, a compress mode, color space information, a pixel count, manufacturer original information (manufacturer note), and the like) as those of Exif (Exchangeable image file format).

As the thumbnail images, as shown in FIG. 7A to 7D, there are a total of four kinds, that is, a thumbnail image of a right viewpoint real image (right eye image in FIG. 5), a thumbnail image of a left viewpoint real image (left eye image in FIG. 5), a thumbnail image of a stereoscopic image, and a thumbnail image of a whole image.

As the real images, as shown in FIGS. 5A to 5D, there are a total of four kinds, that is, a right viewpoint real image, a left viewpoint real image, a real image of a stereoscopic image, and a real image of a whole image.

In this way, since a thumbnail and the like of a whole image which make it possible to grasp the whole, and the whole image (real image) and the like are prepared, it is possible to find out a necessary subject easily.

Subsequently, operations of the digital camera 10 with the above-mentioned construction will be described with referring to drawings.

### [Operation at Photographing]

FIG. 12 is a flowchart for describing an operation (operation at the time of photographing) of the digital camera 10 of the first embodiment.

The following processing is mainly achieved by the CPU 110 executing a predetermined program read into the SDRAM 120 and the like.

When a first step of the shutter button 18 is turned on (step S10: Yes) under a state that either of the 2D photographing mode or 3D photographing mode is set by operation of the mode dial 22, it is detected which of the 2D photographing mode and 3D photographing mode is set (step S11).

When the 2D photographing mode is detected (step S12: No), it is switched to the 2D mode (step S13). That is, a flag which indicates that it is in the 2D mode is set in the 2D/3D mode switching flag 168.

Next, an image pickup device (equivalent to a part of image pickup devices of the present invention) driven out of two image pickup devices R and L (equivalent to two or more image pickup devices of the present invention) is selected (step S14). For example, a user operates the operation unit 112 to select the desired image pickup devices R and L. Display for identifying this selected image pickup device R or L may be performed on the monitor 24 or a display unit separately provided in the camera body 12, for example. When doing in this way, it becomes possible to grasp which of the image pickup devices R and L is driven now or by which of the image pickup devices R and L photographing is performed by a user visually identifying this display. As this display, it is conceivable, for example, to blink the identification number of the image pickup device R or L, or a portion equivalent to the image pickup device R or L, which is driven, in a schematic diagram including the two or more image pickup devices R and L, or to highlight the identification number or portion in a different color.

Subsequently, control is performed so as to drive the image pickup device R or L which is selected at step S14 (step S15).

Next, initialization of a file is executed (step S16).

Subsequently, when a second step of the shutter button 18 is turned on (equivalent to a photographing instruction of the present invention), photographing is performed only by the image pickup device R or L which is selected at step S14 (step S17), and an image (hereinafter, a 2D image) photographed only by the selected image pickup device R or L is captured into SDRAM 120, or the like (step S18).

Next, a real image and a thumbnail image are created from the captured image (step S19), and a file including this real image and thumbnail image is generated and is distributed into a predetermined folder of a recording medium to be recorded (stored) in it (step S20). In addition, the thumbnail image creation circuit 50 creates a thumbnail image.

Then, when the photographing is completed (step S21: Yes), header information is updated (step S22) and the processing is completed.

Next, an operation at the time of the 3D photographing mode being detected at step S12 will be described.

When the 3D photographing mode is detected (step S12: Yes), it is switched to the 3D mode (step S23). That is, a flag which indicates that it is in the 3D mode is set in the 2D/3D mode switching flag 168.

Next, the number of viewpoints is set (step S24). For example, in the case of a digital camera equipped with three image pickup devices, a user sets by which image pickup device photographing is performed, by operating the operation unit 112, or the 2D/3D switching viewpoint number switching unit 48. Since it is a digital camera equipped with two image pickup devices R and L in this embodiment, these two image pickup devices R and L are automatically set as the number of viewpoints (=2). Markings for identifying these set image pickup devices R and L may be displayed on the monitor 24 or a display unit separately provided in the camera body 12, for example. When doing in this way, it becomes possible to grasp which of the image pickup devices R and L is driven now or by which of the image pickup devices R and L photographing is performed by a user visually identifying this display. As these markings, it is conceivable, for example, to blink the identification number of the image pickup device R or L, or a portion equivalent to the image pickup device R or L, which is driven, in a schematic diagram including the two or more image pickup devices R and L, or to highlight the identification number or portion in a different color.

Next, the image pickup devices R and L set at step S24 are selected as drive viewpoints (step S25), and control is performed so as to drive these selected image pickup devices R and L (step S26).

Next, initialization of a file is executed (step S27).

Subsequently, when a second step of the shutter button 18 is turned on (equivalent to a photographing instruction of the present invention), photographing is performed (step S28) by the image pickup devices R and L which are selected at step S25, and images (hereinafter, it is also called a 3D image) photographed by respective image pickup devices R and L are captured into SDRAM 120, or the like (step S29).

While creating a real image at each viewpoint (a real image at a right viewpoint, and a real image at a left viewpoint) from this captured image data at each viewpoint, the 3D image editing circuit 44 creates a 3D image (stereoscopic image) (step S30), and furthermore, the whole image synthetic circuit 42 creates a whole image (step S31).

Next, a thumbnail image of each real image at each viewpoint (the real image at the right viewpoint, and the real image at the left viewpoint), a thumbnail image of the stereoscopic image, and a thumbnail image of the whole image are created (step S32). In addition, the thumbnail image creation circuit 50 creates the thumbnail images.

Subsequently, coordinates of correspondence are created (step S33). That is, information (for example, a position, width, and height in the whole image) of expressing to which portion in the whole image created at step S31 the 3D image (stereoscopic image) created at step S30 corresponds is created (step S33). The information on these coordinates of correspondence makes it possible to express a range of the stereoscopic image, and the like with cursors and the like.

Next, a file including the main image, each thumbnail image, and the coordinates of correspondence which are created as described above is generated, and is automatically distributed into and is recorded (stored) in a predetermined folder of a recording medium (step S34). In addition, this related information such as coordinates of correspondence, four thumbnails, and four real images are divided discriminably with dividing tag codes, and are recorded in one file.

Then, when photographing is completed (step S35: Yes), header information is updated so as to be able to specify the file in the recording medium, the processing is completed (step S35).

As described above, according to the digital camera 10 of this embodiment, from images by a right or left viewpoint which are photographed by two or more image pickup devices R and L corresponding to right and left viewpoints, while two or more real images (a total of four real images of a real image at a right viewpoint, a real image at a left viewpoint, a stereoscopic image, and a whole image) are created (steps S30 and S31), two or more thumbnail images (a total of four thumbnail images of a thumbnail image at a right viewpoint, a thumbnail image at a left viewpoint, a stereoscopic thumbnail image, and a whole thumbnail image) are created (step S32), and they are recorded as an image file in a predetermined image format (step S34).

That is, real images, thumbnail images, and the like, which are classified by the viewpoint, besides a stereoscopic image and a stereoscopic thumbnail image are also recorded.

Hence, as the conventional, even if a portion necessary as a 3D image remains by editing and an image in a portion which does not contribute to 3D display is discarded, it is possible to display a real image, a thumbnail image, and the like, for each of right and left viewpoints, besides a stereoscopic image and a stereoscopic thumbnail image, and hence, it becomes possible to search easily a subject photographed in an image portion and the like in an edge not appearing at 3D display by visually identifying these real images, thumbnail images, and the like for each of the right viewpoint and left viewpoint.

### [Operation at Reproduction—1]

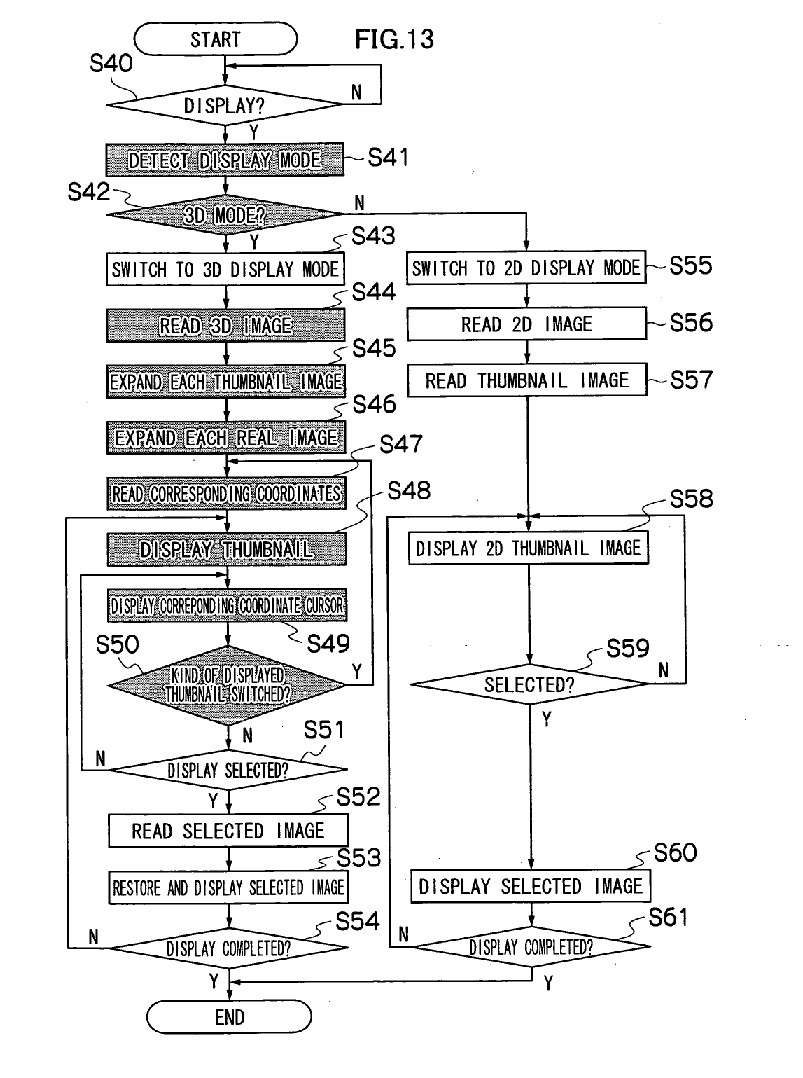

FIG. 13 is a flowchart for describing an operation (operation at the time of reproduction) of the digital camera 10 of the first embodiment.

The following processing is mainly achieved by the CPU 110 executing a predetermined program read into the SDRAM 120 and the like.

When a user operates the operation unit 112 (2D/3D display switching unit) to select which of 2D and 3D images the user intends to display (step S40), it is detected which display mode is selected (step S41).

When a 3D mode is detected (step S42: Yes), it is switched to the 3D display mode (step S43). That is, a flag which indicates that it is in the 3D mode is set in the 2D/3D mode switching flag 168.

Next, 3D images (a file including a stereoscopic image) are read (step S44), respective thumbnail image (four thumbnail images) and respective real images (four real images) of the read 3D images are developed (steps S45 and S46), and further, corresponding coordinates are read from the read 3D image (step S47).

Then, a specific kind of thumbnail image among the developed thumbnail images is displayed on the monitor 24 in a predetermined format (step S48).

Next, cursors are displayed on the corresponding coordinates read at step S47 (step S49). For example, as shown in FIG. 8, the cursor creation circuit 50 displays cursors CR, CL, and CS to a whole image (main image). In addition, display/non-display of these cursors can be switched by a user operating the operation unit 112. In addition, it is also possible to perform switching so that only one of these cursors may be displayed. Thereby, it becomes possible to grasp easily a range of two or more images every viewpoint and a range of a stereoscopic image in a whole image.

In addition, a cursor may be displayed, for example, also to a main image or a thumbnail image at a left viewpoint, not to a whole image (main image). Thereby, it becomes possible to grasp easily a range of a stereoscopic image in at least one image (for example, an image at a left viewpoint) in two or more images every viewpoint.

Furthermore, also when displaying a stereoscopic image, the cursor display of the above-mentioned correspondence can be performed. In addition, it is possible to express in a position, which does not become an obstacle of display of an image, about which position is displayed in a whole image, with a cursor or an image.

When a user operates the operation unit 112 to switch a kind of a thumbnail image, only the switched kind of thumbnail image is displayed (step S50).

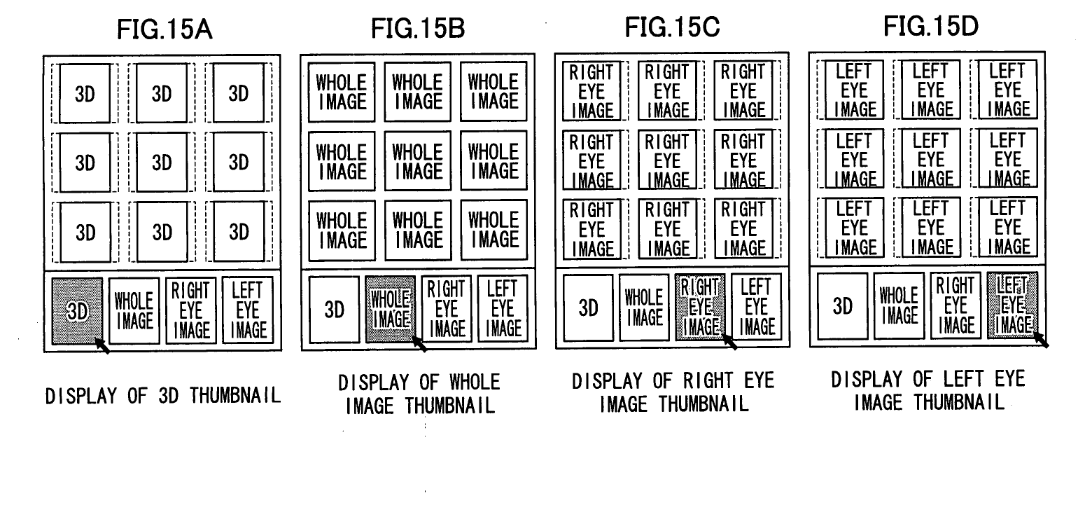

An example of switching of thumbnail images will be shown. For example, as shown in FIG. 15, it is conceivable to switch images in the order of a thumbnail image of a stereoscopic image, a thumbnail image of a whole image, a thumbnail image at a right viewpoint (in the figure, a right eye), a thumbnail image at a left viewpoint (in the figure, a left eye), and a thumbnail image of a stereoscopic image (and so on) every operation of the operation unit 112. For example, a display mode is switched by pressing a mode selection or thumbnail mode selection button, and moving and selecting a cursor. Alternatively, switching may be performed by moving a cursor with a mouse, a track ball, or a touch panel. Furthermore, switching may be performed one by one by toggles of a dedicated button. A default display mode may be a 3D image, whole image, right viewpoint image, or left viewpoint image mode. In addition, it is also sufficient to store a state at the time of final selection to display the thumbnail next time. In addition, when the 3D image mode is selected, it is also possible to switch a display unit to in 3D display to perform the 3D display.

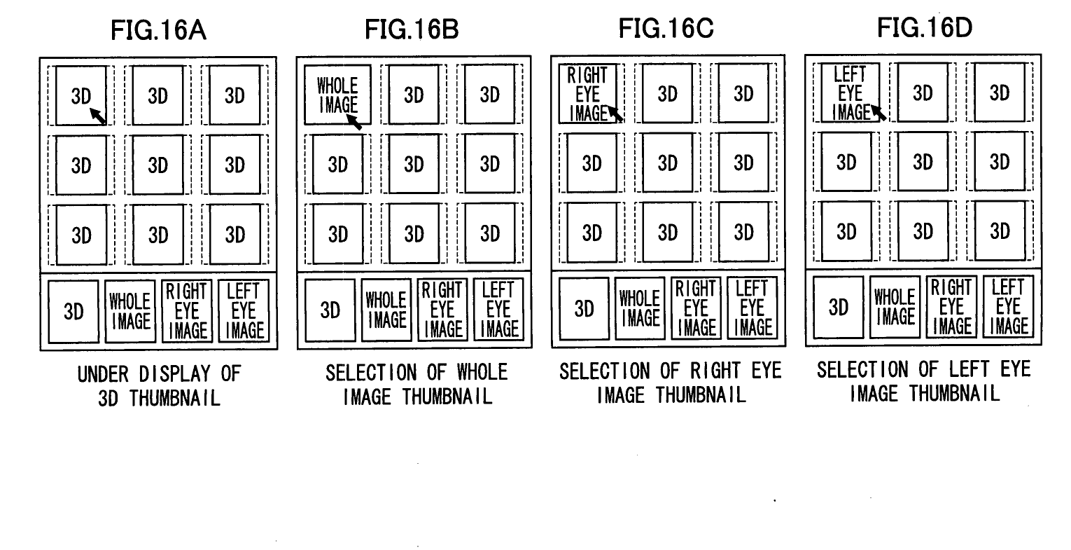

Another example of switching of thumbnail images will be shown. For example, as shown in FIG. 16, it is also sufficient to switch a display of one thumbnail in the order of a 3D image, a whole image, a right viewpoint image, a left viewpoint image, and the 3D image (and so on) every selection by clicking the thumbnail,

When a user operates the operation unit 112 to select one of thumbnail images from the displayed thumbnail images (step S51: Yes), a main image corresponding to the selected thumbnail image and kind is read and restored (steps S52 and S53) to be displayed thereafter (step S52).

A display example of a main image will be described.

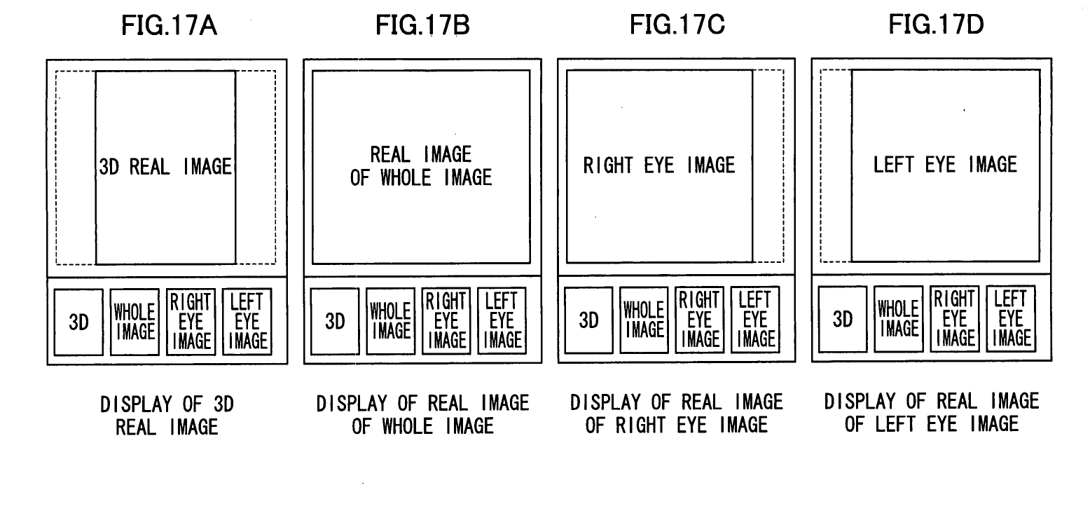

FIG. 17A is a display example of a main image and the like which are displayed when a 3D thumbnail image is selected. FIG. 17B is a display example of a main image and the like which are displayed when a thumbnail image of a whole image is selected. FIG. 17C is a display example of a main image and the like which are displayed when a right viewpoint thumbnail image is selected. FIG. 17D is a display example of a main image and the like which are displayed when a left viewpoint thumbnail image is selected.

By a dedicated selection button, menu selection, or the like after selection with a double click, or a cursor key and a selection key on an image, which a user intends to display, in thumbnail images, a real image of a kind of the thumbnail which is displayed at that time is displayed. It is possible to switch the display mode into a display of a 3D image, a whole image, a right viewpoint image, a left viewpoint image, or a 3D image and a real image by a double click, a menu, or a dedicated display switching key.

Another display example of a main image will be described.

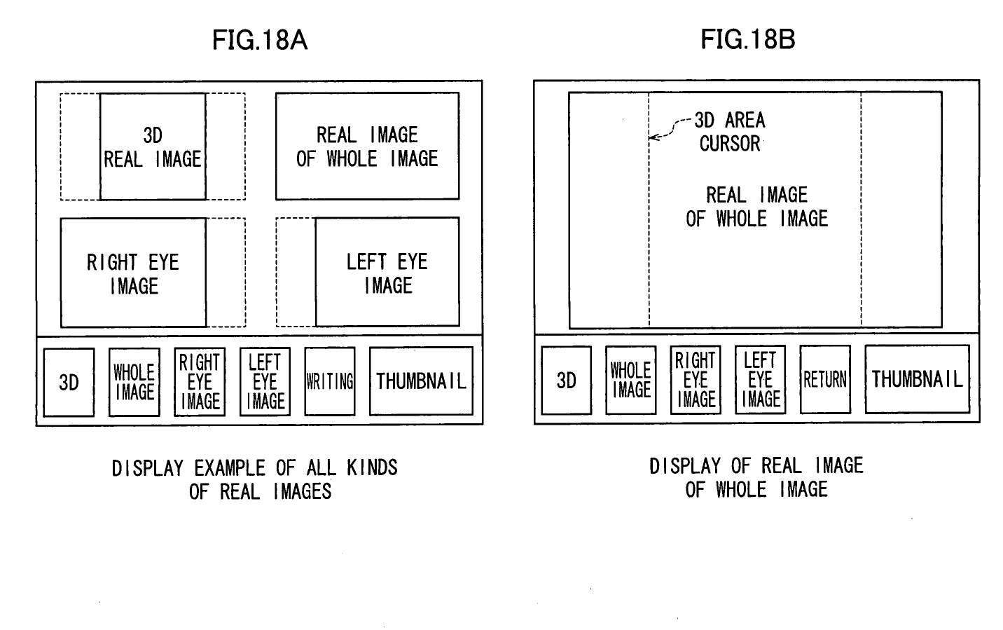

FIG. 18 shows another display example of a main image. As to real image display, it is also possible to display a 3D image, a whole image, a right viewpoint image, and a left viewpoint image side by side. When each image is double-clicked or is selected with a cursor and a selection key, only the selected kind of real image is displayed largely. It is also sufficient to switch a display mode of a display unit to a 3D display mode at the time of a 3D image, and to switch the mode to a 2D display mode in the case of other images. It is possible to return from any image display to the thumbnail display.

The processing of the above-mentioned steps S48 to S53 is repeated until display is completed (step S54: No).

As described above, since a file (image) is read from the 3D image folder which is specific to a 3D image when the 3D mode is detected at step S42, selection becomes easy, and further, it becomes possible also to quickly perform display (display for selection) of a thumbnail image or a real image. In addition, it becomes possible to also perform selection of an image easily.

Next, an operation at the time of the 2D mode being detected at step S42 will be described.

When a 2D mode is detected (step S42: No), it is switched to the 2D display mode (step S55). That is, a flag which indicates that it is in the 2D mode is set in the 2D/3D mode switching flag 168.

Next, while 2D images are read (step S56), thumbnail images of the read 2D images are read (step S57).

Then, the read thumbnail image is displayed on the monitor 24 in a predetermined format (step S58).

When a user operates the operation unit 112 to select any thumbnail image from the displayed thumbnail images (step S59: Yes), a main image corresponding to the selected thumbnail image is displayed (step S60).

The processing of the above-mentioned steps S58 to S60 is repeated until display is completed (step S61: No).

As described above, according to the digital camera 10 of this embodiment, it becomes possible to display a real image of a selected thumbnail image (step S53) by reading and displaying a thumbnail image belonging to at least one kind among a right viewpoint thumbnail image, a left viewpoint thumbnail image, a stereoscopic thumbnail image, and a whole thumbnail image (step S48), switching a kind of the thumbnail image displayed (step S50), and selecting a desired thumbnail image (step S51).

Hence, as the conventional, even if a portion necessary as a 3D image remains by editing and an image in a portion which does not contribute to 3D display is discarded, it is possible to display not only a stereoscopic thumbnail image, but also thumbnail images and the like by viewpoints and the like besides the stereoscopic thumbnail image with switching them, and hence, it becomes possible to easily search a subject photographed in an image portion and the like in an edge not appearing in 3D display by visually identifying the thumbnail images and the like by viewpoint.

### [Operation at Editing]

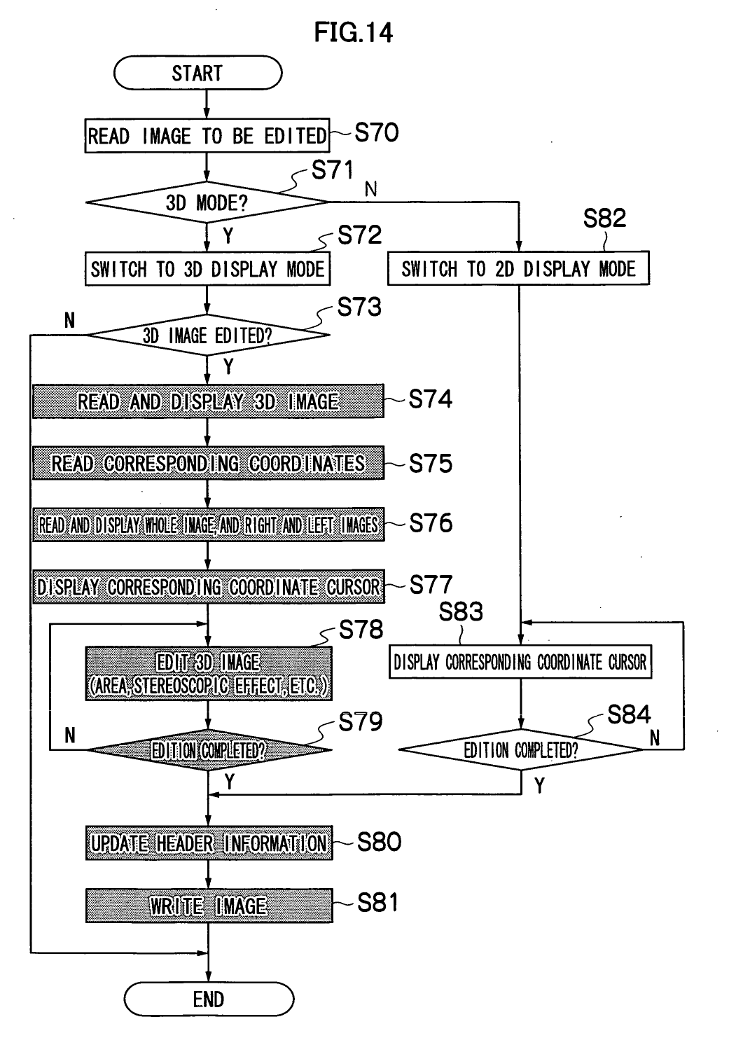

FIG. 14 is a flowchart for describing an operation (operation at editing) of the digital camera 10 of the first embodiment.

The following processing is mainly achieved by the CPU 110 executing a predetermined program read into the SDRAM 120 and the like.

When an image of an editing object is instructed by operation of the operation unit 112, the image concerned is read (step S70).

When the read image is in the 3D mode (step S71: Yes), it is switched to the 3D display mode (step S72). That is, a flag which indicates that it is in the 3D mode is set in the 2D/3D mode switching flag 168.

Next, it is judged whether a 3D image (stereoscopic image) is edited to the image read at step S70 (step S73).

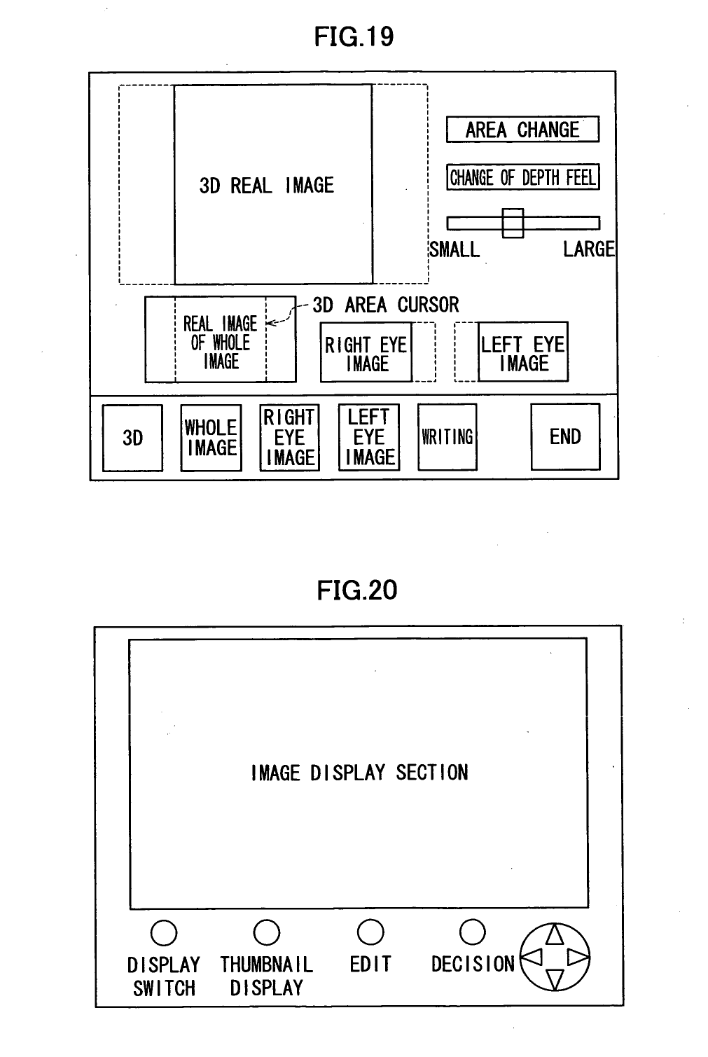

When editing a 3D image (stereoscopic image) (step S73: Yes), a main image (e.g., a whole image) is read and displayed from the 3D image (step S74). In addition, corresponding coordinates are read (step S75). Furthermore, a whole image and right and left viewpoint images are read and displayed (step S76). A display example of these respective images is shown in FIG. 19.

In this display example, the 3D image is large, and others are shown smaller. Although cursors which show a range of the 3D image is displayed on a whole image, s right viewpoint image, and a left viewpoint image, it is possible not to display them by mode selection.

Then, cursors are displayed on the corresponding coordinates read at step S75 (step S77). For example, as shown in FIG. 8, cursors CR, CL, and CS are displayed to the whole image (main image).

Next, the 3D image is edited by operation of the operation unit 112 or edit control input unit 46 (step S78). For example, with avoiding an area adversely affected to adjustment of stereoscopic effect of the 3D image (stereoscopic image) and display of a good stereoscopic image such as a main object and a background, an image range is changed to be a range where beautiful stereoscopic vision can be obtained (it seems to be so).

When this edit is completed (step S79: Yes), header information is updated (step S80), the image after edit is written (step S81), and the processing is completed.

Next, an operation at the time of the 2D mode being detected at step S71 will be described.

When the read image is in the 2D mode (step S71: No), it is switched to the 2D display mode (step S82). That is, a flag which indicates that it is in the 2D mode is set in the 2D/3D mode switching flag 168.

Next, cursors are displayed on the corresponding coordinates (step S83), and the 2D image is edited by operation of the operation unit 112 (step S84).

When this edit is completed (step S84: Yes), header information is updated (step S80), the image after edit is written (step S81), and the processing is completed.

Furthermore, in FIG. 19, when an area change is selected, it is possible to change a range of a 3D region by moving a cursor of the whole image, or a right or left viewpoint image.

In addition, when a whole, right eye, left eye, or 3D button is selected in order to perform detailed edit with displaying an image largely, it is possible to display the image largely. When a return button is selected, the screen returns from the enlarged one to the screen of FIG. 19.

When a depth feel change is selected, depth feel (stereoscopic effect) can be changed with a slide bar. In a simple change, the depth feel is controlled by adjusting a shift amount between right and left (upper and lower) images by a pixel. More detailed depth feel can be changed by adjusting a shift amount foe each area of the image.

FIG. 20 shows an example of key arrangement of the camera. The decision key may be in the center of an arrow key. It is also possible to have construction like a track ball.

As described above, according to the digital camera 10 of this embodiment, since a step (step S78) of editing a range of a stereoscopic image is provided, it becomes possible to edit an image range where beautiful stereoscopic vision is obtained (it seems to be so) with avoiding an area adversely affected to adjustment of a stereoscopic effect and display of a good stereoscopic image such as a main object and a background.

### (Modified Example)

Next, a modified example of the digital camera 10 of this embodiment will be described.

In this embodiment, as shown in FIG. 1, the example that the digital camera 10 is equipped with two image pickup devices R and L is described, but the present invention is not limited to this.

For example, the digital camera 10 may be equipped with three or more photographing devices. In addition, image pickup lenses which construct a photographing device do not need to be placed in a single horizontal row, as shown in FIG. 1. For example, when three image pickup devices are provided, respective image pickup lenses may be placed in positions corresponding to respective vertexes of a triangle. Similarly, when four image pickup devices are provided, respective image pickup lenses may be placed in positions corresponding to respective vertexes of a square.

In this embodiment, for example, at the time of a 3D still image photographing mode, a static image for stereoscopic vision observed by an anaglyph system, a stereoscope system, a parallel method, an intersecting method, or the like is generated, and at the time of 3D moving image photographing mode, 3D moving images in Time-sharing system (TSS) may be generated. In addition, about this kind of 3D image generation method, since it is a publicly-known technique, a description about its specific generation method is omitted here.

In addition, in this embodiment, although reference is not made particularly about voice recording, of course, it is also possible to make voice recording possible.

In addition, the digital camera 10 of this embodiment may be constructed so that a gap between the image pickup devices R and L (mainly image taking lenses 14R and 14L), and an angle of convergence between the image pickup devices R and L (mainly image taking lenses 14R and 14L) can be adjusted according to a photographing purpose by an operation of the predetermined operation unit 112.

The above-mentioned embodiments are only mere exemplification at all points. The present invention is not restrictively interpreted by these descriptions. The present invention can be performed in other various forms without deviating from its spirit or main features.

What is claimed is:

1. An image management method which creates and records two or more real images and two or more thumbnail images from two or more images by viewpoints photographed by two or more image pickup devices corresponding to the viewpoints, wherein
the real images include the images by viewpoints, a stereoscopic image including a common image range cut from the images by viewpoints and a whole image synthesized from the images by viewpoints, and
the thumbnail images include two or more thumbnail images by each viewpoint corresponding to each of the images by viewpoints, a 3D thumbnail image corresponding to the stereoscopic image, and a whole thumbnail image corresponding to the whole image.

2. The image management method according to claim 1, comprising,
displaying the whole image and a marking for indicating a range of the images by viewpoints in the whole image or a range of the stereoscopic image in the whole image.

3. The image management method according to claim 1, comprising,
displaying at least one image of the images by viewpoints and a marking for indicating a range of the stereoscopic image in the displayed image.

4. A compound eye digital camera which is equipped with two or more image pickup devices corresponding to two or more viewpoints, comprising:
a creation device which not only creates as real images two or more images by viewpoints photographed by the image pickup devices, a stereoscopic image including a common image range cut from the images by viewpoints, and a whole image synthesized from the images by viewpoints, but also creates two or more thumbnail images by viewpoints corresponding to each of the images by viewpoints respectively, a stereoscopic thumbnail image corresponding to the stereoscopic image, and a whole thumbnail image corresponding to the whole image;
a thumbnail image display device which displays a thumbnail image belonging to at least one kind among the thumbnail images by viewpoints, the stereoscopic thumbnail image, and the whole thumbnail image;
a switching device which switches a kind of a thumbnail image displayed by the display device;
a selection device which makes a desired thumbnail image selected among from thumbnail images displayed by the display device;
a real image display device which displays a real image corresponding to the thumbnail image selected by the selection device;
an edit device which edits a range of the stereoscopic image; and
a stereoscopic thumbnail image creation device which creates and changes a stereoscopic thumbnail image corresponding to the stereoscopic image after the edit.

5. An image management method which creates and records two or more real images and two or more thumbnail images from two or more images by viewpoints photographed by two or more image pickup devices corresponding to the viewpoints, comprising:
a step of performing photographing by the image pickup devices;
a step of creating the images by viewpoints and two or more thumbnail images by viewpoints corresponding to the images by viewpoints respectively;
a step of designating a range which is stereoscopically displayable from the images by viewpoints, cutting out an image corresponding to the designated range as a stereoscopic image from the image by viewpoints, and creating a stereoscopic thumbnail image corresponding to the stereoscopic image;
a step of creating a whole image synthesized from the images by viewpoints, and a whole thumbnail image corresponding to the whole image; and
a step of recording the images by viewpoints, thumbnail image by viewpoints, the stereoscopic image, the stereoscopic thumbnail image, the whole image, and the whole thumbnail image, which are created at the respective steps, on a recording medium.

6. An image reproducing method, which reproduces two or more images by viewpoints photographed by two or more image pickup devices corresponding to the viewpoints, comprising:
a step of reading and displaying a thumbnail image belonging to at least one kind among thumbnail images by viewpoints corresponding to the images by viewpoints respectively, a stereoscopic thumbnail image corresponding to a stereoscopic image cut out from the images by viewpoints in a stereoscopically displayable range, and a whole thumbnail image corresponding to a whole image synthesized from the images by viewpoints;
a step of switching a kind of the thumbnail image displayed;
a step of reading and displaying a thumbnail image belonging to the kind which is switched;
a step of making a desired thumbnail image selected among from the thumbnail images displayed; and
a step of displaying a real image corresponding to the thumbnail image selected.

7. An image reproducing method, which reproduces two or more images by viewpoints photographed by two or more image pickup devices corresponding to the viewpoints, comprising:
a step of reading and displaying a thumbnail image belonging to at least one kind among thumbnail images by viewpoints corresponding to the images by viewpoints respectively, a stereoscopic thumbnail image corresponding to a stereoscopic image cut out from the images by viewpoints in a stereoscopically displayable range, and a whole thumbnail image corresponding to a whole image synthesized from the images by viewpoints;
a step of making a thumbnail image to be edited, selected from the thumbnail images displayed;
a step of displaying a stereoscopic image corresponding to the thumbnail image selected;
a step of editing a range of the stereoscopic image displayed;
a step of creating and changing a stereoscopic thumbnail image corresponding to the stereoscopic image after the edit; and
a step of recording the stereoscopic image and the stereoscopic thumbnail image after the edit on a recording medium.
